(19) United States
(12) Patent Application Publication
(10) Pub. No.: US 2026/0138913 A1
(43) Pub. Date: May 21, 2026

(54) ZIRCON-COMPATIBLE ALKALI GLASSES

(71) Applicant: CORNING INCORPORATED, CORNING, NY (US)

(72) Inventors: Darren William Schnare, Horseheads, NY (US); Liying Zhang, Painted Post, NY (US); Yi Zhang, Round Rock, TX (US)

(21) Appl. No.: 19/119,459

(22) PCT Filed: Oct. 10, 2023
(86) PCT No.: PCT/US2023/034773

§ 371 Date: Apr. 9, 2025

Related U.S. Application Data
(60) Provisional application No. 63/418,082, filed on Oct. 21, 2022.

(51) Int. Cl. C03C 3/085; C03C 3/091; C03C 3/097

(52) U.S. Cl. CPC C03C 3/085; C03C 3/091; C03C 3/097

(57) ABSTRACT

A zircon-compatible glass includes SiO₂ that is 50 mol % to 77 mol % of the glass, Al₂O₃ that is 2 mol % to 22 mol % of the glass, and R₂O, wherein R₂O—Al₂O₃ is 5 mol % to 15 mol % of the glass, wherein R is Li, Na, and/or K. The glass is a sodium-rich glass comprising Na₂O that is 14 mol % to 22 mol % of the glass and K₂O that is 0 mol % to 7.6 mol % of the glass, or the glass is a potassium-rich glass comprising K₂O that is 7 mol % to 13 mol % of the glass and Na₂O that is 0 mol % to 14% of the glass.

### CROSS-REFERENCE TO RELATED APPLICATIONS

This application claims the benefit of priority under 35 U.S.C. § 119 of U.S. Provisional Application No. 63/418,082 filed Oct. 21, 2022, the content of which is incorporated herein by reference in its entirety.

### FIELD OF INVENTION

This application relates to a zircon (ZrSiO4) compatible alkali containing glass, and more specifically to glass that contains at least 14 mol % of Na₂O or at least 7 mol % of K2O.

### BACKGROUND

Alkali-containing glasses have been studied for many applications. Those glasses can have a high coefficient of thermal expansion (CTE), a low 3-D forming temperature, a low liquidus temperature, and can be strengthened by ion exchange. The overflow process, also known as the fusion draw process, is an industrial technique for large scale manufacture of glass sheets. The fusion draw process involves the flow of molten glass over a forming pipe, known as an “isopipe”. The isopipe is made of zircon (ZrSiO₄) and/or other refractory materials. Zircon is currently the mostly common isopipe material. During the fusion draw process, glass overflows the top of the isopipe, descends over two opposite sides of the isopipe, and meets to fuse together and form a sheet at the bottom of the isopipe. The isopipe is continuously exposed to glass flow during the process. Chemical reactions between the isopipe material and the glass composition can create defects in the produced glass. The defects can impact glass quality and potentially can pose some risk to the refractory materials depending on the defect size and level.

Zircon can dissociate or break down to zirconia (ZrO₂) and silica (SiO₂) at temperatures higher than 1665° C. (e.g., ZrSiO₄(s)→ZrO₂(s)+SiO₂(m), where “s” means solid and “m” means in glass melt state). One potential zircon-glass compatibility issue is that glass components that lower SiO₂ activity, especially R₂O (wherein R is K, Na, and/or Li) and Al₂O₃, can decrease zircon breakdown onset temperature (T_{zbd}). Another possible compatibility issue is the formation of zirconia-containing secondary phases that can precipitate on zircon (e.g., as a layer clinging to the zircon refractory) and/or form solid inclusions in glass. The tendency to form secondary crystalline phases increases with decreasing temperature and varies with glass composition. Many glass compositions do not contain any secondary zirconia-containing phases other than those formed from dissociated zircon. One example of a secondary zirconia-containing phase is parakeldyshite (PKS), which can be formed from the reaction SiO₂(m)+ZrO₂(m)+Na₂O(m)→Na₂ZrSi₂O₇ (s), also called parakeldyshite (PKS).

### SUMMARY OF THE INVENTION

In various aspects, the present invention provides a glass that includes SiO₂ that is 50 mol % to 77 mol % of the glass. The glass includes Al₂O₃ that is 2 mol % to 22 mol % of the glass. The glass includes R₂O, wherein R₂O—Al₂O₃ is 5 mol % to 15 mol % of the glass, wherein R is Li, Na, and/or K. The glass is a sodium-rich glass comprising Na₂O that is 14 mol % to 22 mol % of the glass and K₂O that is 0 mol % to 7.6 mol % of the glass, or the glass is a potassium-rich glass including K₂O that is 7 mol % to 13 mol % of the glass and Na₂O that is 0 mol % to 14% of the glass.

In various aspects, the present invention provides a glass that includes SiO₂ that is 50 mol % to 77 mol % of the glass. The glass includes Al₂O₃ that is 6 mol % to 22 mol % of the glass. The glass includes R₂O, wherein R₂O—Al₂O₃ is 9 mol % to 15 mol % of the glass, wherein R is Li, Na, and/or K. The glass includes B₂O₃ that is 0 mol % to 10 mol % of the glass. The glass includes P₂O₅ that is 0 mol % to 13 mol % of the glass. The glass includes Li₂O that is 0 mol % to 10 mol % of the glass. The glass includes Na₂O that is 14 mol % to 22 mol % of the glass. The glass includes K₂O that is 0 mol % to 7.6 mol % of the glass. R₂O—B₂O₃—P₂O₅—Al₂O₃ is less than 5 mol % of the glass.

In various aspects, the present invention provides a glass including SiO₂ that is 60 mol % to 75 mol % of the glass. The glass includes Al₂O₃ that is 2 mol % to 22 mol % of the glass. The glass includes R₂O, wherein R₂O—Al₂O₃ is 5 mol % to 11 mol % of the glass, wherein R is Li, Na, and/or K. The glass includes B₂O₃ that is 0 mol % to 10 mol % of the glass. The glass includes P₂O₅ that is 0 mol % to 13 mol % of the glass. The glass includes Li₂O that is 0 mol % to 10 mol % of the glass. The glass includes Na₂O that is 0 mol % to 14 mol % of the glass. The glass includes K₂O that is 7 mol % to 13 mol % of the glass. R₂O—B₂O₃—P₂O₅—Al₂O₃ is less than 1.9 mol % of the glass.

In various aspects, the present invention provides a starting composition for forming the glass of the present invention. The starting composition includes the same composition as the glass of the present invention.

In various aspects, the present invention provides a method of processing the glass of the present invention, or of processing a starting composition for forming the glass of the present invention which has the composition as the glass of the present invention. The method includes processing the glass or starting composition for forming glass at a temperature that does not exceed a predicted T_{zbd}, wherein the predicted T_{zbd} is Tzbd_{predicted}=Σ(Oxideᵢ×Coefficentᵢ)+intercept. Coefficientᵢ is the coefficient for oxide i, and oxideᵢ is the mol % of oxide i. If P₂O₅ is greater than 0.01 mol % of the glass or starting composition for forming glass, then the intercept is 1692; for Al₂O₃, the coefficient is −9.5; for B₂O₃, the coefficient is −7.2; for P₂O₅, the coefficient is 20.6; for Li₂O, the coefficient is −21.4; for Na₂O, the coefficient is −24.5; for K₂O, the coefficient is −24.5; for MgO, the coefficient is −14.7; for CaO, the coefficient is 15.2; for CrO, the coefficient is −17.5; for BaO, the coefficient is −6.5; and for ZnO, the coefficient is −7.8. If P₂O₅ is less than or equal to than 0.01 mol % of the glass or starting composition for forming glass, then the intercept is 1421; for Al₂O₃, the coefficient is −17.6; for B₂O₃, the coefficient is −2.2; for P₂O₅, the coefficient is 0.0; for Li₂O, the coefficient is −19.7; for Na₂O, the coefficient is −24.6; for K₂O, the coefficient is −33.1; for MgO, the coefficient is −9.2; for CaO, the coefficient is −9.1; for CrO, the coefficient is −15.6; for BaO, the coefficient is −4.2; and for ZnO, the coefficient is 0.0.

Various aspects of the glass composition and method of the present invention have certain advantages over other glass compositions and methods of processing the same. For example, in various aspects, the glass composition of the present invention is zircon-compatible and has a high CTE, such as a linear expansion CTE of greater than or equal to 10 ppm/° C. at room temperature. In various embodiments, the glass composition of the present invention is such that it can be processed at a temperature below the zircon breakdown onset temperature (T_{zbd}), preventing or reducing the breakdown of zircon into zirconia and silica. In various aspects, the glass composition of the present invention can be varied to tune the T_{zbd} to a desired temperature. In various aspects, the glass composition of the present invention is such that can be processed at a temperature that is above the temperature at which secondary zirconia-containing phases form in the glass composition, thereby preventing or reducing the formation of secondary zirconia-containing phases on zircon refractory materials and/or as solid inclusions in the produced glass. In various aspects, the glass composition of the present invention can have a high CTE, such as a linear expansion CTE of greater than or equal to 10 ppm/° C. at room temperature. In various aspects, the glass composition of the present invention can be chemically strengthened to gain surface compression for stronger mechanical properties, which can be desirable for glass substrates used in semiconductor manufacturing. In various aspects, the high CTE of the glass composition can provide benefits in specific applications such as glass carriers or sealing materials in composites.

### BRIEF DESCRIPTION OF THE FIGURES

The drawings illustrate generally, by way of example, but not by way of limitation, various aspects of the present invention.

FIG. 1A illustrates T_{zbd} versus SiO₂ mol % for various glass compositions, in accordance with various aspects.

FIG. 1B illustrates T_{bzd} versus Al₂O₃ mol % for various glass compositions, in accordance with various aspects.

FIG. 1C illustrates T_{bzd} versus P₂O₅ mol % for various glass compositions, in accordance with various aspects.

FIG. 2A illustrates T_{zbd} versus mol % R₂O for various glass compositions, in accordance with various aspects.

FIG. 2B illustrates T_{zbd} versus mol % Li₂O for various glass compositions, in accordance with various aspects.

FIG. 2C illustrates T_{bzd} versus mol % Na₂O for various glass compositions, in accordance with various aspects.

FIG. 2D illustrates T_{zbd} versus mol % K₂O for various glass compositions, in accordance with various aspects.

FIG. 3A illustrates predicted T_{zbd} versus experimentally determined T_{zbd} of various glass compositions for training, in accordance with various aspects.

FIG. 3B illustrates predicted T_{zbd} versus experimentally determined T_{zbd} of various glass compositions for training, in accordance with various aspects.

FIG. 4A illustrates predicted T_{zbd} versus experimentally determined T_{zbd} of various glass compositions for training, in accordance with various aspects.

FIG. 4B illustrates predicted T_{zbd} versus experimentally determined T_{zbd} of various glass compositions for training, in accordance with various aspects.

FIG. 5 illustrates the importance of various oxides on T_{bzd} of glass compositions, in accordance with various aspects.

FIG. 6 illustrates T_{zbd} or T(reaction) versus measured T_{bzd} for various glass compositions, in accordance with various aspects.

FIG. 7 illustrates R₂O—B₂O₃—P₂O₅—Al₂O₃ mol % versus Na₂O mol % for various glass compositions, in accordance with various aspects.

FIG. 8 illustrates R₂O—B₂O₃—P₂O₅—Al₂O₃ mol % versus Na₂O mol % for various glass compositions, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.10% to about 5%” or “about 0.10% to 5%” should be interpreted to include not just about 0.10% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

### Glass.

Various aspects of the present invention provide a glass. The glass can include SiO₂ that is 50 mol % to 77 mol % of the glass. The glass can include Al₂O₃ that is 2 mol % to 22 mol % of the glass. The glass can also include R₂O, wherein R₂O—Al₂O₃ (i.e., the mol % of R₂O minus the mol % of Al₂O₃) is 5 mol % to 15 mol % of the glass, wherein R is Li, Na, and/or K. The glass can be a sodium-rich glass including Na₂O that is 14 mol % to 22 mol % of the glass and K₂O that is 0 mol % to 7.6 mol % of the glass, or the glass can be a potassium-rich glass including K₂O that is 7 mol % to 13 mol % of the glass and Na₂O that is 0 mol % to 14% of the glass.

The glass can include B₂O₃, or the glass can be substantially free of B₂O₃; for example, B₂O₃ can be 0 mol % to 10 mol % of the glass, 0.01 mol % to 10 mol % of the glass, 0.01 mol % to 1 mol % of the glass, or less than or equal to 10 mol % or greater than or equal to 0 mol %, 0.001, 0.005, 0.01, 0.05, 0.1, 0.5, 1, 1.5, 2, 3, 4, 5, 6, 7, 8, or 9 mol %.

The glass can include P₂O₅, or the glass can be substantially free of P₂O₅; for example, P₂O₅ can be 0 mol % to 13 mol % of the glass, 0.01 mol % to 13 mol % of the glass, 0.01 mol % to 1 mol % of the glass, or less than or equal to 13 mol % and greater than or equal to 0 mol %, 0.001, 0.005, 0.01, 0.05, 0.1, 0.5, 1, 1.5, 2, 3, 4, 5, 6, 7, 8, 9, 10, 11, or 12 mol %.

The glass can include Li₂O, or the glass can be substantially free of Li₂O; for example, Li₂O can be 0 mol % to 10 mol % of the glass, 0.01 mol % to 10 mol % of the glass, 0.01 mol % to 1 mol % of the glass, or less than or equal to 10 mol % and greater than or equal to 0 mol %, 0.001, 0.005, 0.01, 0.05, 0.1, 0.5, 1, 1.5, 2, 3, 4, 5, 6, 7, 8, or 9 mol %.

The glass can include R₂O, wherein R is Li, Na, and/or K; for example, R₂O can be 10 mol % to 35 mol % of the glass, 14 mol % to 20 mol % of the glass, or less than or equal to 35 mol % and greater than or equal to 10 mol %, 12, 14, 15, 16, 17, 18, 19, 20, 22, 24, 26, 28, 30, 32, or 34 mol %.

The glass can be sodium-rich glass, wherein the glass includes Na₂O that is 14 mol % to 22 mol % of the glass and K₂O that is 0 mol % to 7.6 mol % of the glass. In the sodium-rich glass, SiO₂ can be 50 mol % to 77 mol % of the glass, such as less than or equal to 77 mol % and greater than or equal to 50 mol %, 52, 54, 56, 58, 60, 62, 64, 66, 68, 70, 72, 74, or 76 mol %. In the sodium-rich glass, Al₂O₃ can be 6 mol % to 22 mol % of the glass, such as less than or equal to 22 mol % and greater than or equal to 6 mol %, 7, 8, 9, 10, 11, 12, 13, 14, 15, 16, 17, 18, 19, 20, or 21 mol %. In the sodium-rich glass, R₂O—Al₂O₃ can be 9 mol % to 15 mol % of the glass, such as less than or equal to 15 mol % and greater than or equal to 9 mol %, 10, 11, 12, 13, or 14 mol %. In the sodium-rich glass, K₂O can be 0.01 mol % to 7.6 mol % of the glass, 0.01 mol % to 1 mol % of the glass, or less than or equal to 7.6 mol % and greater than or equal to 0.01 mol %, 0.05, 0.1, 0.5, 1, 1.5, 2, 2.5, 3, 3.5, 4, 4.5, 5, 5.5, 6, 6.5, 7, or 7.5 mol %. In the sodium-rich glass, R₂O—B₂O₃—P₂O₅—Al₂O₃ (i.e., the mol % of R₂O minus the mol % of B₂O₃ minus the mol % of P₂O₅ minus the mol % of Al₂O₃) can be less than 5 mol % of the glass, or 0.01 mol % to 5 mol % of the glass, or less than or equal to 5 mol % and greater than or equal to 0 mol %, 0.001, 0.005, 0.01, 0.05, 0.1, 0.5, 1, 1.5, 2, 2.5, 3, 3.5, 4, or 4.5 mol %.

The sodium-rich glass can include SiO₂ that is 50 mol % to 77 mol % of the glass; Al₂O₃ that is 6 mol % to 22 mol % of the glass; R₂O, wherein R₂O—Al₂O₃ is 9 mol % to 15 mol % of the glass, wherein R is Li, Na, and/or K; B₂O₃ that is 0 mol % to 10 mol % of the glass; P₂O₅ that is 0 mol % to 13 mol % of the glass; Li₂O that is 0 mol % to 10 mol % of the glass; Na₂O that is 14 mol % to 22 mol % of the glass; and K₂O that is 0 mol % to 7.6 mol % of the glass. R₂O—B₂O₃—P₂O₅—Al₂O₃ can be less than 5 mol % of the sodium-rich glass.

The glass can be potassium-rich glass, wherein the glass includes K₂O that is 7 mol % to 13 mol % of the glass and Na₂O that is 0 mol % to 14% of the glass. In the potassium-rich glass, SiO₂ can be 60 mol % to 75 mol % of the glass, or less than or equal to 75 mol % and greater than or equal to 60 mol %, 61, 62, 63, 64, 65, 66, 67, 68, 69, 70, 71, 72, 73, or 74 mol %. In the potassium-rich glass, Al₂O₃ can be 2 mol % to 22 mol % of the glass, or less than or equal to 22 mol % and greater than or equal to 2 mol %, 3, 4, 5, 6, 7, 8, 9, 10, 11, 12, 13, 14, 15, 16, 17, 18, 19, 20, or 21 mol %. In the potassium-rich glass, R₂O—Al₂O₃ can be 5 mol % to 11 mol % of the glass, or less than or equal to 11 mol % and greater than or equal to 5 mol %, 6, 7, 8, 9, or 10 mol %. In the potassium-rich glass, Na₂O can be 0.01 mol % to 14 mol % of the glass, or 0.01 mol % to 1 mol % of the glass, or less than or equal to 14 mol % and greater than or equal to 0.01 mol %, 0.05, 0.1, 0.5, 1, 2, 3, 4, 5, 6, 7, 8, 9, 10, 11, 12, or 13 mol %. In the potassium-rich glass, R₂O—B₂O₃—P₂O₅—Al₂O₃ is less than 1.9 mol % of the glass, or 0.01 mol % to 1.9 mol % of the glass, or less than or equal to 1.9 mol % and greater than or equal to 0 mol %, 0.001, 0.005, 0.01, 0.05, 0.1, 0.2, 0.4, 0.6, 0.8, 1, 1.2, 1.4, 1.6, or 1.8 mol %.

The potassium-rich glass can include SiO₂ that is 60 mol % to 75 mol % of the glass; Al₂O₃ that is 2 mol % to 22 mol % of the glass; R₂O, wherein R₂O—Al₂O₃ is 5 mol % to 11 mol % of the glass, wherein R is Li, Na, and/or K; B₂O₃ that is 0 mol % to 10 mol % of the glass; P₂O₅ that is 0 mol % to 13 mol % of the glass; Li₂O that is 0 mol % to 10 mol % of the glass; Na₂O that is 0 mol % to 14 mol % of the glass; and K₂O that is 7 mol % to 13 mol % of the glass; wherein R₂O—B₂O₃—P₂O₅—Al₂O₃ is less than 1.9 mol % of the glass.

The glass can have any suitable coefficient of thermal expansion (CTE), such as a linear expansion CTE. The glass can have a linear expansion CTE of 5 ppm/° C. to 50 ppm/° C., or 10 ppm/° C. to 40 ppm/° C., or less than or equal to 50 ppm/° C. and greater than or equal to 5 ppm/° C., 10, 12, 14, 16, 18, 20, 22, 24, 26, 28, 30, 32, 34, 36, 38, 40, or 45 ppm/° C. The linear expansion CTE can be measured using any suitable technique, such a gradient boat test.

The glass can have any suitable zircon breakdown onset temperature (T_{zbd}), which is the temperature at which zircon breaks down or dissociates to zirconia and silica, such as a TbAd of 900° C. to 1400° C., 950° C. to 1400° C., 950° C. to 1300° C., 1050° C. to 1250° C., or less than or equal to 1400° C. and greater than or equal to 900° C., 910, 920, 930, 940, 950, 960, 970, 980, 990, 1000, 1010, 1020, 1030, 1040, 1050, 1060, 1080, 1100, 1120, 1140, 1160, 1180, 1200, 1220, 1240, 1250, 1260, 1280, 1300, or 1350° C. The glass can be substantially free of solid inclusions including zircon secondary phase, such as parakeldyshite, wadeite, a solid solution of parakeldyshite and gittinsite, or a combination thereof. The glass can be substantially free of zirconia.

In various aspects, P₂O₅ is greater than 0.01 mol % of the glass and the glass has a zircon breakdown onset temperature (T_{zbd}) of Tzbd_{predicted}=Σ(Oxideᵢ×Coefficentᵢ)+intercept. Coefficientᵢ is a coefficient for oxide i, and Oxideᵢ is the mol % of oxide i; the intercept is 1692; for Al₂O₃, the coefficient is −9.5; for B₂O₃, the coefficient is −7.2; for P₂O₅, the coefficient is 20.6; for Li₂O, the coefficient is −21.4; for Na₂O, the coefficient is −24.5; for K₂O, the coefficient is −24.5; for MgO, the coefficient is −14.7; for CaO, the coefficient is 15.2; for CrO, the coefficient is −17.5; for BaO, the coefficient is −6.5; and for ZnO, the coefficient is −7.8.

In various aspects, P₂O₅ is less than or equal to than 0.01 mol % of the glass and the glass has a zircon breakdown onset temperature (T_{zbd}) of Tzbd_{predicted}=Σ(Oxideᵢ×Coefficentᵢ)+intercept. Coefficientᵢ is a coefficient for oxide i, and oxideᵢ is the mol % of oxide i; the intercept is 1421; for Al₂O₃, the coefficient is −17.6; for B₂O₃, the coefficient is −2.2; for P₂O₅, the coefficient is 0.0; for Li₂O, the coefficient is −19.7; for Na₂O, the coefficient is −24.6; for K₂O, the coefficient is −33.1; for MgO, the coefficient is −9.2; for CaO, the coefficient is −9.1; for CrO, the coefficient is −15.6; for BaO, the coefficient is −4.2; and for ZnO, the coefficient is 0.0.

### Starting Composition for Forming Glass.

In various aspects, the present invention provides a starting composition for forming the glass of the present invention. The starting composition has the same composition as the glass of the present invention. The starting composition can include SiO₂ that is 50 mol % to 77 mol % of the starting composition. The starting composition can include Al₂O₃ that is 2 mol % to 22 mol % of the starting composition. The starting composition can also include R₂O, wherein R₂O—Al₂O₃ is 5 mol % to 15 mol % of the starting composition, wherein R is Li, Na, and/or K. The starting composition can be a sodium-rich starting composition including Na₂O that is 14 mol % to 22 mol % of the starting composition and K₂O that is 0 mol % to 7.6 mol % of the starting composition, or the starting composition can be a potassium-rich starting composition including K₂O that is 7 mol % to 13 mol % of the starting composition and Na₂O that is 0 mol % to 14% of the starting composition.

### Method of Processing Glass.

Various aspects of the present invention provide a method of processing the glass of the present invention or a method of processing the starting composition for forming the glass of the present invention. The method can include processing the glass or starting composition for forming glass at a temperature that does not exceed a predicted T_{zbd}, wherein the predicted T_{zbd} is Tzbd_{predicted}=Σ(Oxideᵢ×Coefficentᵢ)+intercept. Coefficientᵢ is a coefficient for oxide i, and oxideᵢ is the mol % of oxide i. If P₂O₅ is greater than 0.01 mol % of the glass or starting composition for forming glass, then the intercept is 1692; for Al₂O₃, the coefficient is −9.5; for B₂O₃, the coefficient is −7.2; for P₂O₅, the coefficient is 20.6; for Li₂O, the coefficient is −21.4; for Na₂O, the coefficient is −24.5; for K₂O, the coefficient is −24.5; for MgO, the coefficient is −14.7; for CaO, the coefficient is 15.2; for CrO, the coefficient is −17.5; for BaO, the coefficient is −6.5; and for ZnO, the coefficient is −7.8. If P₂O₅ is less than or equal to than 0.01 mol % of the glass or starting composition for forming glass, then the intercept is 1421; for Al₂O₃, the coefficient is −17.6; for B₂O₃, the coefficient is −2.2; for P₂O₅, the coefficient is 0.0; for Li₂O, the coefficient is −19.7; for Na₂O, the coefficient is −24.6; for K₂O, the coefficient is −33.1; for MgO, the coefficient is −9.2; for CaO, the coefficient is −9.1; for CrO, the coefficient is −15.6; for BaO, the coefficient is −4.2; and for ZnO, the coefficient is 0.0.

The predicted T_{zbd} can be any suitable T_{zbd}; for example, the predicted T_{zbd} can be 900° C. to 1400° C., 950° C. to 1400° C., 1050° C. to 1250° C., 950° C. to 1250° C. or less than or equal to 1400° C. and greater than or equal to 900° C., 910, 920, 930, 940, 950, 960, 970, 980, 990, 1000, 1010, 1020, 1030, 1040, 1050, 1060, 1080, 1100, 1120, 1140, 1160, 1180, 1200, 1220, 1240, 1250, 1260, 1280, 1300, or 1350° C.

The method can include processing the glass or starting composition for forming glass at a temperature that does not exceed the predicted T_{zbd} and that is above 400° C., 500, 600, 700, 800, 900, 950, 1000, 1050, 1100, 1150, 1200, 1250, 1300, or above 1350° C. The method can include processing the glass or starting composition for forming glass at a temperature that does not exceed the predicted T_{zbd} and that is within 50° C. of the predicted T_{zbd}, or within 10° C. of the predicted T_{zbd}, or within 2° C., 4, 6, 8, 10, 15, 20, 40, 60, 80, 100, 120, 140, 160, 180, 200, 220, 240, 260, 280, or within 300° C. of the predicted T_{zbd}. The method can include processing the glass or starting composition for forming glass at a temperature within the range of, and that does not exceed, 900° C. to 1400° C., 950° C. to 1300° C., or less than or equal to 1400° C. and greater than or equal to 900° C., 950, 1000, 1050, 1100, 1150, 1200, 1250, 1300, or 1350° C. In various aspects, the tendency to form, or rate of formation of, secondary crystalline phases increases with decreasing temperature, and varies between different glass compositions.

The method can include processing the glass or starting composition for forming glass with zircon refractory equipment. The zircon refractory equipment can include a zircon isopipe.

### EXAMPLES

Various aspects of the present invention can be better understood by reference to the following Examples which are offered by way of illustration. The present invention is not limited to the Examples given herein.

In the Examples, T_{zbd} was measured as the temperature at which zircon is observed to be dissociated to ZrO₂ using the zircon breakdown test. In the test, glass cullet along with zircon sample was heat-treated in a gradient furnace for 72 hours or longer.

### Example 1. Influence of Composition of T_{zbd}

Various glass compositions (1250 in total) and their respective T_{zbd} measurements were collected from Corning's database. The dataset included 475 P₂O₅-containing glass compositions and 775 P₂O₅-free glass.

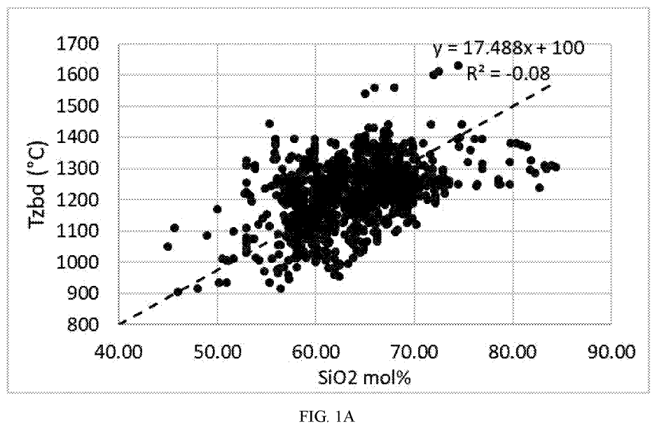

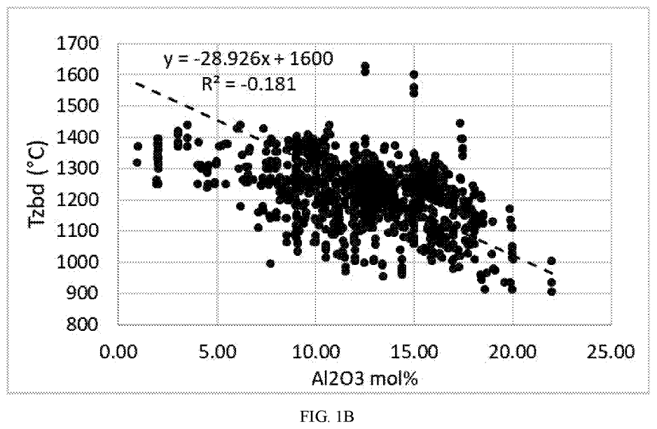

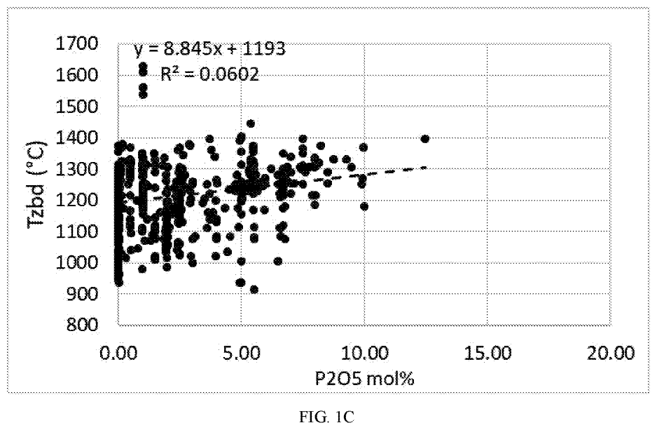

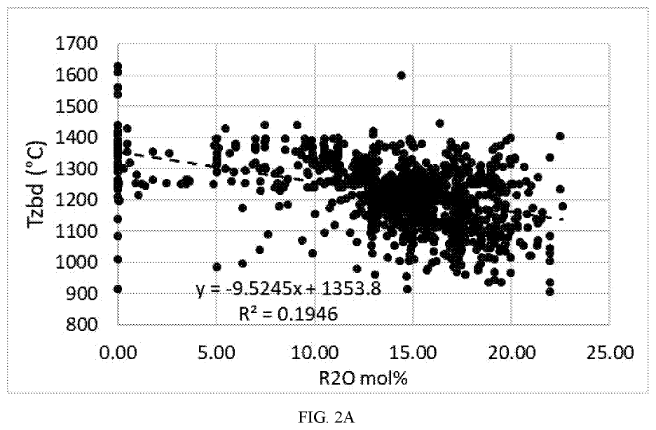

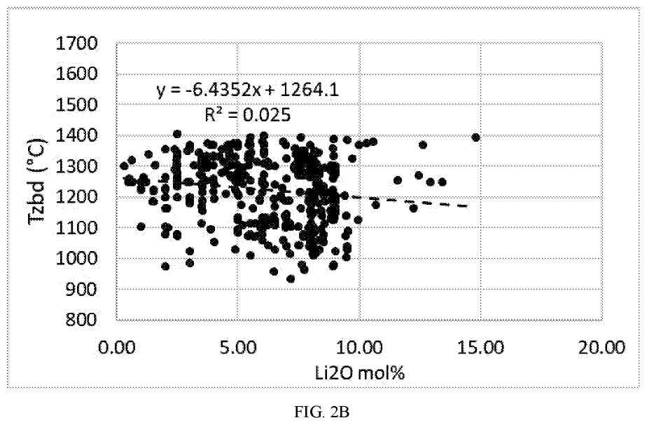

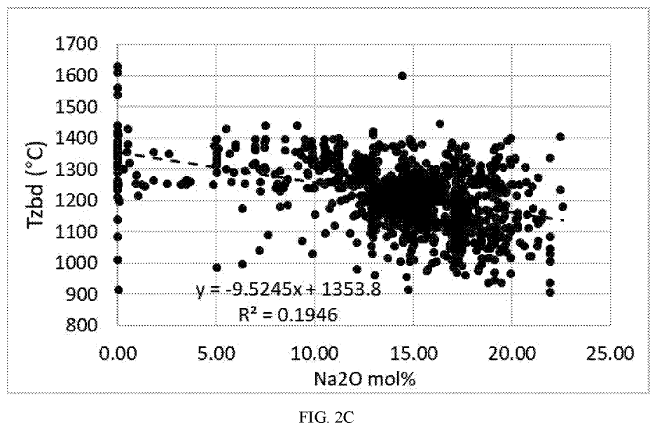

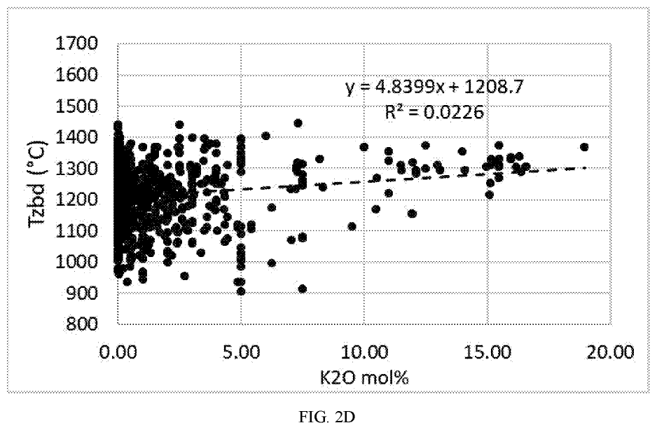

T_{zbd} overall increased with increasing SiO₂ content in the glass (FIG. 1A) and decreased with increasing concentration of Al₂O₃(FIG. 1B). The addition of P₂O₅ increases T_{zbd} (see FIG. 1C). Any addition of glass network modifiers decreases T_{zbd}. However, ignoring the interference of other oxides and nonlinear impact, the impact of individual R₂O on T_{zbd} can be observed. FIG. 2A illustrates T_{zbd} versus mol % R₂O for various glass compositions. FIG. 2B illustrates T_{zbd} versus mol % Li₂O for various glass compositions. FIG. 2C illustrates T_{zbd} versus mol % Na₂O for various glass compositions. FIG. 2D illustrates T_{zbd} versus mol % K₂O for various glass compositions. High K₂O concentration glasses are not observed with lower T_{zbd} due to the addition of P₂O₅ in glass in FIG. 2D.

The dissolution of the zircon dissociation product SiO₂ into glass is a driving force for the decomposition/breakdown reaction of zircon. Based on the thermodynamics of the zircon breakdown reaction and general individual oxide impact, higher R₂O and Al₂O₃ concentrations in glass can drop T_{zbd} of that glass significantly, while glass T_{zbd} increases overall with increasing SiO₂ mol % of the glass.

Linear regression was used to study the compositional impact on zircon breakdown temperature. The predicted T_{zbd} was calculated based on the oxide, coefficients, and intercept as:

$${Tzbd}_{predicted} = \sum ( {Oxide}_{i} \times {Coefficent}_{i} ) + intercept$$

where i is the total number of oxides in the model.

Table 1 shows the linear regression fitting factors for T_{zbd} prediction with each oxide (mol %). The model accuracy for the two group compositions are calculated to be higher than 80%.

TABLE 1
Summary of Linear Regression Model
with oxide fitting parameters.

| | |
|---|---|
| High alkali groups | Coefficients |

| Glass composition (mol %) | P₂O₅ > 0.01 | P₂O₅ ≤ 0.01 |
|---|---|---|
| Al₂O₃ | −9.5 | −17.6 |
| B₂O₃ | −7.2 | −2.2 |
| P₂O₅ | 20.6 | 0.0 |
| Li₂O | −21.4 | −19.7 |
| Na₂O | −24.5 | −24.6 |
| K₂O | −24.5 | −33.1 |
| MgO | −14.7 | −9.2 |
| CaO | 15.2 | −9.1 |
| SrO | −17.5 | −15.6 |
| BaO | −6.5 | −4.2 |
| ZnO | −7.8 | 0.0 |
| Intercept | 1692 | 1421 |

Note:
Parameters for the oxides (ZrO₂, TiO₂, SnO₂ and La₂O₃) that have very limited range or numbers in the database were not included.

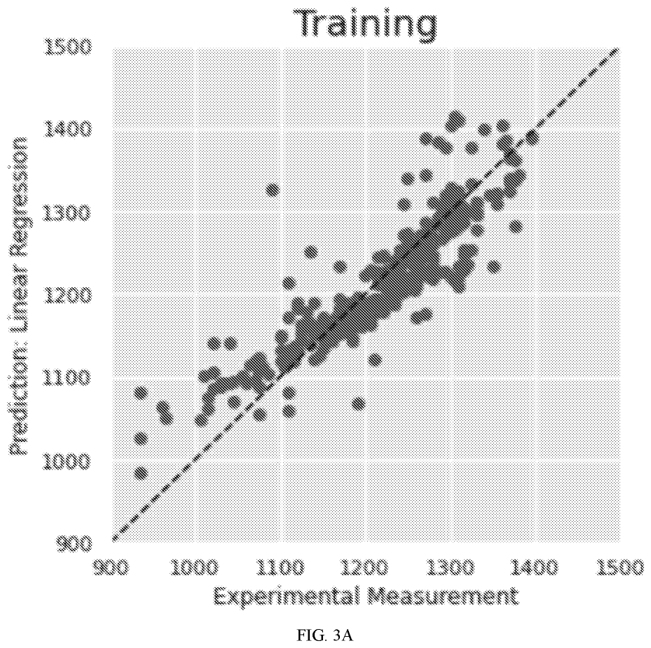

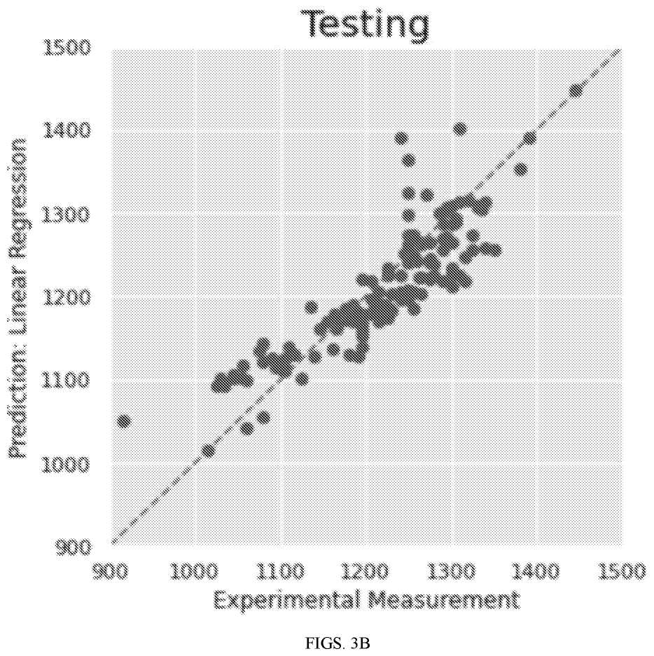

There was a total of 475 data points for glasses with P₂O₅>0.01. The data set was split to 70% training set and 30% testing set. The accuracy of the model on both training and testing sets was around 80%. FIG. 3A illustrates predicted T_{zbd} versus experimentally determined T_{zbd} of the P₂O₅-containing glass compositions for training. FIG. 3B illustrates predicted T_{zbd} versus experimentally determined T_{zbd} of the P₂O₅-containing glass compositions for training. shows a comparison of predictions and experimental measurements on training set and testing set, respectively.

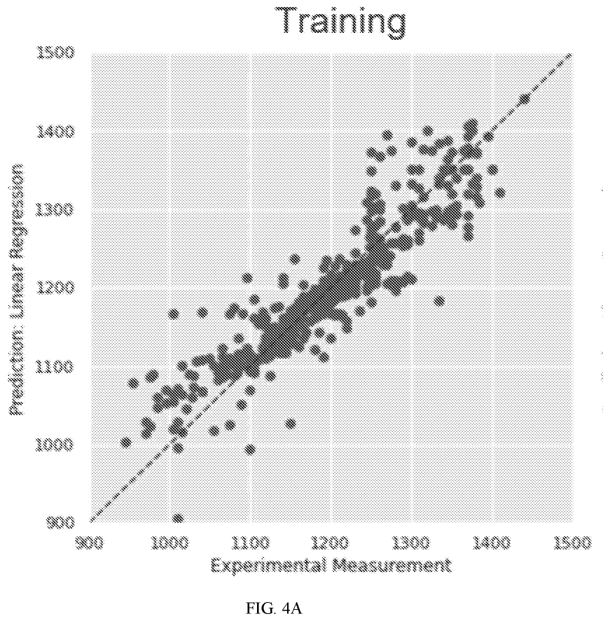

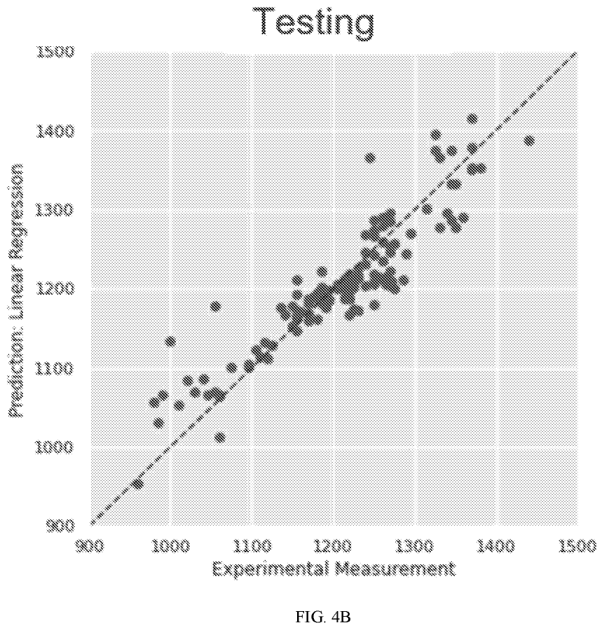

For P₂O₅-free alkali silicate glasses in the database, the data set was split to 70% training set and 30% testing set. The model accuracy was 82% in the training set and 84% on testing set. FIG. 4A illustrates predicted T_{zbd} versus experimentally determined T_{zbd} of the P₂O₅-free R₂O—B₂O₃>0 glass compositions for training. FIG. 4B illustrates predicted T_{zbd} versus experimentally determined T_{zbd} of the P₂O₅-free R₂O—B₂O₃>0 glass compositions for training.

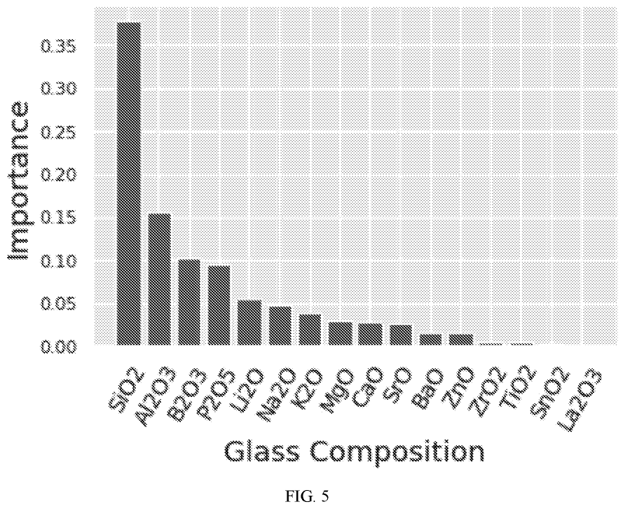

The importance of each oxide were studied with a random forest method, with importance of each oxide shown in FIG. 5.

### Example 2. Influence of Composition on Presence of Secondary Phase

From the database described in Example 1, all occurrences of test glasses that generated a secondary zirconia-containing silicate were compiled. Seventy-two tests contained parakeldyshite (PKS, Na₂ZrSi₂O₇), twenty-one contained a solid solution phase (SS) compositionally between parakeldyshite and gittinsite (CaZrSi₂O₇), and eight contained wadeite (K₂ZrSi₃O₉).

The compositions with observed crystallizations of parakeldyshite, wadeite, and the solid solution are found to contain excessively high levels of alkali. In this report, the highest temperature that crystals of PKS or WAD formed was called T(reaction) (e.g., T(PKS), T(WAD)). The secondary phase PKS or WAD or SS, was formed from the devitrification of the very localized glass next to zircon materials.

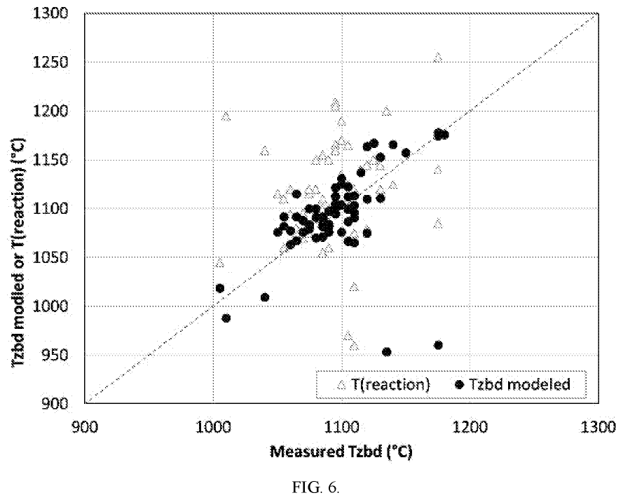

First, the T_{zbd} measurements of the reaction composition groups overall followed prediction of linear regression obtained from Example 1 (although there were two outliers). However, the T(reaction) measurements, i.e., the highest temperature of crystallization phase, was not consistent with T_{zbd}. That indicated some different compositional impact and complexity of T(reaction) compared to zircon breakdown. FIG. 6 illustrates T_{zbd} or T(reaction) versus measured T_{zbd}.

### Example 2A. Parakeldyshite Formation Compositions

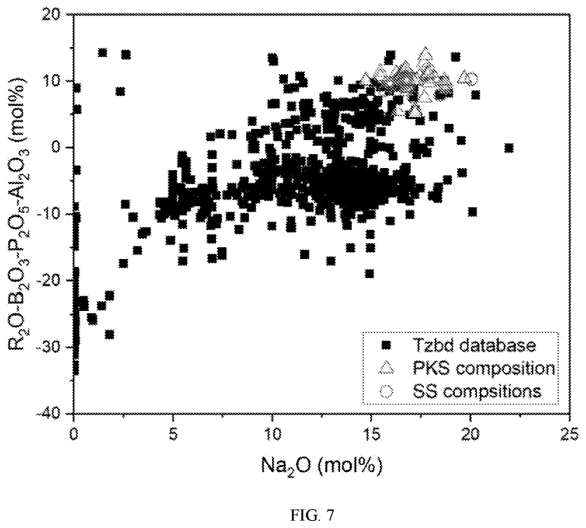

FIG. 7 illustrates R₂O—B₂O₃—P₂O₅—Al₂O₃ mol % versus Na₂O mol % for PKS- and SS-containing compositions from the zircon breakdown test database, compared to other compositions from the database. Glasses that showed PKS or SS formation in the zircon breakdown tests contained high Na₂O mol % and higher excessive R₂O relative to B₂O₃, P₂O₅ and Al₂O₃. The excessive alkali can provide a higher dissolution rate of zircon materials, which is not studied quantitatively in this work.

Table 2 gives a summary of the glass compositions that contained PKS. The glass compositions that contained PKS had Na₂O content above 14.7 mol % and excessive R₂O (relative to B₂O₃, P₂O₅, Al₂O₃) above 5.2 mol %. Na₂O content and excessive R₂O content relative to (B₂O₃+P₂O₅+Al₂O₃) are suggested for evaluating the risk of forming secondary phase PKS.

TABLE 2
PKS-containing glass composition summary.

| Mol % | SiO₂ | Al₂O₃ | P₂O₅ | Na₂O | R₂O—B₂O₃—P₂O₅—Al₂O₃ |
|---|---|---|---|---|---|
| Min | 51.7 | 6.8 | 0.0 | 14.7 | 5.2 |
| Max | 70.8 | 13.7 | 2.0 | 20.0 | 13.9 |

### Example 2B. Wadeite Formation Compositions

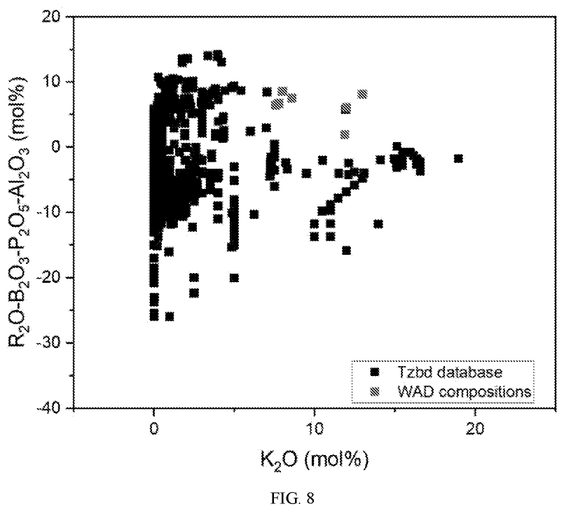

FIG. 8 illustrates R₂O—B₂O₃—P₂O₅—Al₂O₃ mol % versus Na₂O mol % for WAD-containing compositions from the database, compared to other compositions from the database. Glass compositions that showed WAD in the zircon breakdown tests contained high K₂O mol % and excessive R₂O relative to B₂O₃, P₂O₅ and Al₂O₃.

Table 3 gives a summary of the glass compositions that contained WAD. The glass compositions that contained WAD had K₂O content above 7.6 mol % and excessive R₂O (relative to B₂O₃, P₂O₅, and Al₂O₃) above 1.9 mol %.

TABLE 3
WAD-containing glass composition summary.

| Mol % | SiO₂ | Al₂O₃ | P₂O₅ | K₂O | R₂O—B₂O₃—P₂O₅—Al₂O₃ |
|---|---|---|---|---|---|
| Min | 63.9 | 2.0 | 0.0 | 7.6 | 1.9 |
| Max | 73.8 | 7.4 | 1.4 | 13.0 | 8.6 |

K₂O and excessive R₂O relative to (B₂O₃+P₂O₅+Al₂O₃) are suggested for evaluating the risk of forming secondary phase WAD. Based on the analysis above, compositions having a high risk for forming WAD have K₂O>7.6 mol %, and R₂O—B₂O₃—P₂O₅—Al₂O₃>1.9 mol %.

The secondary phase is likely devitrification, probably caused from the local glass composition near to zircon materials. The concentration or activities of oxides that form the phase can be the major driving force for the second phase formation. For that, it is fair to evaluate this type of zircon-glass reaction by some factors that are related to refractory dissolution and alkali content, although some interference from different oxides and other complexity are not included.

### Example 3. Analysis of Examples 1 and 2. Zircon-Compatible High Alkali Compositional Region

Based on the Example 1 and Example 2, 2A, and 2B studies on compositional impact on zircon-glass compatibility, glass with good zircon compatibility at glass process temperatures (in the range of 950° C. to 1300° C., which corresponds to the temperature at which the glass has a viscosity of 35k poise) is proposed in Table 4 below. These compositions can provide glass manufacturable through a zircon refractory-containing platform. These compositions have high linear expansion CTE due to the high R₂O content.

TABLE 4
Zircon-compatible glass compositions.

| Glass composition | mol % | mol % |
|---|---|---|
| SiO₂ | 50-77 | 60-75 |
| Al₂O₃ | 6-22 | 2-22 |
| B₂O₃ | 0-10 | 0-10 |
| P₂O₅ | 0-13 | 0-13 |
| Li₂O | 0-10 | 0-10 |
| Na₂O | 14-22 | 0-14 |
| K₂O | 0-7.6 | 7-13 |
| R₂O—Al₂O₃ | 9-15 | 5-11 |
| R₂O—B₂O₃—P₂O₅—Al₂O₃ | <5 | <1.9 |

R = Li, Na, and/or K.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects

The following exemplary aspects are provided, the numbering of which is not to be construed as designating levels of importance:

Aspect 1 provides a glass comprising:
SiO₂ that is 50 mol % to 77 mol % of the glass;
Al₂O₃ that is 2 mol % to 22 mol % of the glass; and
R₂O, wherein R₂O—Al₂O₃ is 5 mol % to 15 mol % of the glass, wherein R is Li, Na, and/or K;
wherein
   the glass is a sodium-rich glass comprising Na₂O that is 14 mol % to 22 mol % of the glass and K₂O that is 0 mol % to 7.6 mol % of the glass, or
   the glass is a potassium-rich glass comprising K₂O that is 7 mol % to 13 mol % of the glass and Na₂O that is 0 mol % to 14% of the glass.

Aspect 2 provides the glass of Aspect 1, wherein B₂O₃ is 0 mol % to 10 mol % of the glass.

Aspect 3 provides the glass of any one of Aspects 1-2, wherein B₂O₃ is 0.01 mol % to 10 mol % of the glass.

Aspect 4 provides the glass of any one of Aspects 1-3, wherein B₂O₃ is 0.01 mol % to 1 mol % of the glass.

Aspect 5 provides the glass of any one of Aspects 1-4, wherein P₂O₅ is 0 mol % to 13 mol % of the glass.

Aspect 6 provides the glass of any one of Aspects 1-5, wherein P₂O₅ is 0.01 mol % to 13 mol % of the glass.

Aspect 7 provides the glass of any one of Aspects 1-6, wherein P₂O₅ is 0.01 mol % to 1 mol % of the glass.

Aspect 8 provides the glass of any one of Aspects 1-7, wherein Li₂O that is 0 mol % to 10 mol % of the glass.

Aspect 9 provides the glass of any one of Aspects 1-8, wherein Li₂O is 0.01 mol % to 10 mol % of the glass.

Aspect 10 provides the glass of any one of Aspects 1-9, wherein Li₂O is 0.01 mol % to 1 mol % of the glass.

Aspect 11 provides the glass of any one of Aspects 1-10, wherein R₂O is 10 mol % to 35 mol % of the glass.

Aspect 12 provides the glass of any one of Aspects 1-11, wherein R₂O is 14 mol % to 20 mol % of the glass.

Aspect 13 provides the glass of any one of Aspects 1-12, wherein the glass is the sodium-rich glass.

Aspect 14 provides the glass of Aspect 13, wherein SiO₂ is 50 mol % to 77 mol % of the glass.

Aspect 15 provides the glass of any one of Aspects 13-14, wherein Al₂O₃ is 6 mol % to 22 mol % of the glass.

Aspect 16 provides the glass of any one of Aspects 13-15, wherein R₂O—Al₂O₃ is 9 mol % to 15 mol % of the glass.

Aspect 17 provides the glass of any one of Aspects 13-16, wherein K₂O is 0.01 mol % to 7.6 mol % of the glass.

Aspect 18 provides the glass of any one of Aspects 13-17, wherein K₂O is 0.01 mol % to 1 mol % of the glass.

Aspect 19 provides the glass of any one of Aspects 13-18, wherein R₂O—B₂O₃—P₂O₅—Al₂O₃ is less than 5 mol % of the glass.

Aspect 20 provides the glass of any one of Aspects 13-19, wherein R₂O—B₂O₃—P₂O₅—Al₂O₃ is 0.01 mol % to 5 mol % of the glass.

Aspect 21 provides the glass of any one of Aspects 1-12, wherein the glass is the potassium-rich glass.

Aspect 22 provides the glass of Aspect 21, wherein SiO₂ is 60 mol % to 75 mol % of the glass.

Aspect 23 provides the glass of any one of Aspects 21-22, wherein Al₂O₃ is 2 mol % to 22 mol % of the glass.

Aspect 24 provides the glass of any one of Aspects 21-23, wherein R₂O—Al₂O₃ is 5 mol % to 11 mol % of the glass.

Aspect 25 provides the glass of any one of Aspects 21-24, wherein Na₂O is 0.01 mol % to 14 mol % of the glass.

Aspect 26 provides the glass of any one of Aspects 21-25, wherein Na₂O is 0.01 mol % to 1 mol % of the glass.

Aspect 27 provides the glass of any one of Aspects 21-26, wherein R₂O—B₂O₃—P₂O₅—Al₂O₃ is less than 1.9 mol % of the glass.

Aspect 28 provides the glass of any one of Aspects 21-27, wherein R₂O—B₂O₃—P₂O₅—Al₂O₃ is 0.01 mol % to 1.9 mol % of the glass.

Aspect 29 provides the glass of any one of Aspects 1-28, wherein the glass has a linear coefficient of thermal expansion (CTE) of 5 ppm/° C. to 50 ppm/° C.

Aspect 30 provides the glass of any one of Aspects 1-29, wherein the glass has a linear coefficient of thermal expansion (CTE) of 10 ppm/° C. to 40 ppm/° C.

Aspect 31 provides the glass of any one of Aspects 1-30, wherein the glass has a zircon breakdown onset temperature (T_{zbd}) of 900° C. to 1400° C.

Aspect 32 provides the glass of any one of Aspects 1-31, wherein the glass has a zircon breakdown onset temperature (T_{zbd}) of 1050° C. to 1250° C.

Aspect 33 provides the glass of any one of Aspects 1-32, wherein the glass is substantially free of solid inclusions comprising zircon secondary phase.

Aspect 34 provides the glass of any one of Aspects 1-33, wherein the glass is substantially free of zirconia.

Aspect 35 provides the glass of any one of Aspects 1-34, wherein P₂O₅ is greater than 0.01 mol % of the glass and the glass has a zircon breakdown onset temperature (T_{zbd}) of

$${Tzbd}_{predicted} = \sum ( {Oxide}_{i} \times {Coefficent}_{i} ) + intercept$$

wherein
   coefficientᵢ is a coefficient for oxide i, and oxideᵢ is the mol % of oxide i,
   the intercept is 1692,
   for Al₂O₃, the coefficient is −9.5,
   for B₂O₃, the coefficient is −7.2,
   for P₂O₅, the coefficient is 20.6,
   for Li₂O, the coefficient is −21.4,
   for Na₂O, the coefficient is −24.5,
   for K₂O, the coefficient is −24.5,
   for MgO, the coefficient is −14.7,
   for CaO, the coefficient is 15.2,
   for CrO, the coefficient is −17.5,
   for BaO, the coefficient is −6.5, and
   for ZnO, the coefficient is −7.8.

Aspect 36 provides the glass of any one of Aspects 1-34, wherein P₂O₅ is less than or equal to than 0.01 mol % of the glass and the glass has a zircon breakdown onset temperature (T_{zbd}) of

$${Tzbd}_{predicted} = \sum ( {Oxide}_{i} \times {Coefficent}_{i} ) + intercept$$

wherein
   coefficientᵢ is a coefficient for oxide i, and oxideᵢ is the mol % of oxide i,
   the intercept is 1421.
   for Al₂O₃, the coefficient is −17.6,
   for B₂O₃, the coefficient is −2.2,
   for P₂O₅, the coefficient is 0.0,
   for Li₂O, the coefficient is −19.7,
   for Na₂O, the coefficient is −24.6,
   for K₂O, the coefficient is −33.1,
   for MgO, the coefficient is −9.2,
   for CaO, the coefficient is −9.1,
   for CrO, the coefficient is −15.6,
   for BaO, the coefficient is −4.2, and
   for ZnO, the coefficient is 0.0.

Aspect 37 provides a glass comprising: SiO₂ that is 50 mol % to 77 mol % of the glass; Al₂O₃ that is 6 mol % to 22 mol % of the glass; R₂O, wherein R₂O—Al₂O₃ is 9 mol % to 15 mol % of the glass, wherein R is Li, Na, and/or K;
B₂O₃ that is 0 mol % to 10 mol % of the glass;
P₂O₅ that is 0 mol % to 13 mol % of the glass;
Li₂O that is 0 mol % to 10 mol % of the glass;
Na₂O that is 14 mol % to 22 mol % of the glass; and
K₂O that is 0 mol % to 7.6 mol % of the glass;
wherein R₂O—B₂O₃—P₂O₅—Al₂O₃ is less than 5 mol % of the glass.

Aspect 38 provides a glass comprising:
SiO₂ that is 60 mol % to 75 mol % of the glass;
Al₂O₃ that is 2 mol % to 22 mol % of the glass;
R₂O, wherein R₂O—Al₂O₃ is 5 mol % to 11 mol % of the glass, wherein R is Li, Na, and/or K;
B₂O₃ that is 0 mol % to 10 mol % of the glass;
P₂O₅ that is 0 mol % to 13 mol % of the glass;
Li₂O that is 0 mol % to 10 mol % of the glass;
Na₂O that is 0 mol % to 14 mol % of the glass; and
K₂O that is 7 mol % to 13 mol % of the glass;
wherein R₂O—B₂O₃—P₂O₅—Al₂O₃ is less than 1.9 mol % of the glass.

Aspect 39 provides a starting composition for forming the glass of any one of Aspects 1-38, the starting composition comprising the same composition as the glass of any one of Aspects 1-38.

Aspect 40 provides a method of processing the glass of any one of Aspects 1-38, or a starting composition for forming the glass of any one of Aspects 1-38 having the same composition as the glass of any one of Aspects 1-38, the method comprising:
processing the glass or starting composition for forming glass at a temperature that does not exceed a predicted T_{zbd}, wherein the predicted T_{zbd} is

$${Tzbd}_{predicted} = \sum ( {Oxide}_{i} \times {Coefficent}_{i} ) + intercept$$

wherein coefficientᵢ is a coefficient for oxide i, and oxideᵢ is the mol % of oxide i;
wherein if P₂O₅ is greater than 0.01 mol % of the glass or starting composition for forming glass, then
   the intercept is 1692,
   for Al₂O₃, the coefficient is −9.5,
   for B₂O₃, the coefficient is −7.2,
   for P₂O₅, the coefficient is 20.6,
   for Li₂O, the coefficient is −21.4,
   for Na₂O, the coefficient is −24.5,
   for K₂O, the coefficient is −24.5,
   for MgO, the coefficient is −14.7,
   for CaO, the coefficient is 15.2,
   for CrO, the coefficient is −17.5,
   for BaO, the coefficient is −6.5, and
   for ZnO, the coefficient is −7.8; and
wherein if P₂O₅ is less than or equal to than 0.01 mol % of the glass or starting composition for forming glass, then
   the intercept is 1421.
   for Al₂O₃, the coefficient is −17.6,
   for B₂O₃, the coefficient is −2.2,
   for P₂O₅, the coefficient is 0.0,
   for Li₂O, the coefficient is −19.7,
   for Na₂O, the coefficient is −24.6,
   for K₂O, the coefficient is −33.1,
   for MgO, the coefficient is −9.2,
   for CaO, the coefficient is −9.1,
   for CrO, the coefficient is −15.6,
   for BaO, the coefficient is −4.2, and
   for ZnO, the coefficient is 0.0.

Aspect 41 provides the method of Aspect 40, wherein the predicted T_{zbd} is 900° C. to 1400° C.

Aspect 42 provides the method of any one of Aspects 40-41, wherein the predicted T_{zbd} is 1050° C. to 1250° C.

Aspect 43 provides the method of any one of Aspects 40-42, wherein the method comprises processing the glass or starting composition for forming glass at a temperature that does not exceed the predicted T_{zbd} and that is above 400° C.

Aspect 44 provides the method of any one of Aspects 40-43, wherein the method comprises processing the glass or starting composition for forming glass at a temperature that does not exceed the predicted T_{zbd} and above a temperature that is above 800° C.

Aspect 45 provides the method of any one of Aspects 40-44, wherein the method comprises processing the glass or starting composition for forming glass at a temperature that does not exceed the predicted T_{zbd} and that is within 50° C. of the predicted T_{zbd}.

Aspect 46 provides the method of any one of Aspects 40-45, wherein the method comprises processing the glass or starting composition for forming glass at a temperature that does not exceed the predicted T_{zbd} and that is within 10° C. of the predicted T_{zbd}.

Aspect 47 provides the method of any one of Aspects 40-46, wherein the method comprises processing the glass or starting composition for forming glass at a temperature of 900° C. to 1400° C.

Aspect 48 provides the method of any one of Aspects 40-47, wherein the method comprises processing the glass or starting composition for forming glass at a temperature of 950° C. to 1300° C.

Aspect 49 provides the method of any one of Aspects 40-48, wherein the method comprises processing the glass or starting composition for forming glass with zircon refractory equipment.

Aspect 50 provides the method of any one of Aspects 40-49, wherein the zircon refractory equipment comprises a zircon isopipe.

Aspect 51 provides the glass, glass starting composition, or method of any one or any combination of Aspects 1-50 optionally configured such that all elements or options recited are available to use or select from.

1. A glass comprising:
SiO₂ that is 50 mol % to 77 mol % of the glass;
Al₂O₃ that is 2 mol % to 22 mol % of the glass; and
R₂O, wherein R₂O—Al₂O₃ is 5 mol % to 15 mol % of the glass, wherein R is Li, Na, and/or K;
wherein
the glass is a sodium-rich glass comprising Na₂O that is 14 mol % to 22 mol % of the glass and K₂O that is 0 mol % to 7.6 mol % of the glass, or
the glass is a potassium-rich glass comprising K₂O that is 7 mol % to 13 mol % of the glass and Na₂O that is 0 mol % to 14% of the glass.

2. The glass of claim 1, wherein
B₂O₃ is 0 mol % to 10 mol % of the glass;
P₂O₅ is 0 mol % to 13 mol % of the glass; and
Li₂O is 0 mol % to 10 mol % of the glass.

3. The glass of claim 1, wherein R₂O is 10 mol % to 35 mol % of the glass.

4. The glass of claim 1, wherein the glass is the sodium-rich glass, wherein
SiO₂ is 50 mol % to 77 mol % of the glass;
Al₂O₃ is 6 mol % to 22 mol % of the glass;
R₂O—Al₂O₃ is 9 mol % to 15 mol % of the glass;
K₂O is 0.01 mol % to 7.6 mol % of the glass; and
R₂O—B₂O₃—P₂O₅—Al₂O₃ is less than 5 mol % of the glass.

5. The glass of claim 1, wherein the glass is the potassium-rich glass, wherein
SiO₂ is 60 mol % to 75 mol % of the glass;
Al₂O₃ is 2 mol % to 22 mol % of the glass;
R₂O—Al₂O₃ is 5 mol % to 11 mol % of the glass; and
Na₂O is 0.01 mol % to 14 mol % of the glass.

6. The glass of claim 1, wherein the glass has a linear coefficient of thermal expansion (CTE) of 5 ppm/° C. to 50 ppm/° C.

7. The glass of claim 1, wherein the glass has a linear coefficient of thermal expansion (CTE) of 10 ppm/° C. to 40 ppm/° C.

8. The glass of claim 1, wherein the glass has a zircon breakdown onset temperature (T_{zbd}) of 900° C. to 1400° C.

9. The glass of claim 1, wherein the glass has a zircon breakdown onset temperature (T_{zbd}) of 1050° C. to 1250° C.

10. The glass of claim 1, wherein the glass is substantially free of solid inclusions comprising zircon secondary phase, and wherein the glass is substantially free of zirconia.

11. The glass of claim 1, wherein P₂O₅ is greater than 0.01 mol % of the glass and the glass has a zircon breakdown onset temperature (T_{zbd}) of
$${Tzbd}_{predicted} = \sum ( {Oxide}_{i} \times {Coefficent}_{i} ) + intercept$$
wherein
coefficientᵢ is a coefficient for oxide i, and oxideᵢ is the mol % of oxide i,
oxideᵢ is the mol % of oxide i,
the intercept is 1692,
for Al₂O₃, the coefficient is −9.5,
for B₂O₃, the coefficient is −7.2,
for P₂O₅, the coefficient is 20.6,
for Li₂O, the coefficient is −21.4,
for Na₂O, the coefficient is −24.5,
for K₂O, the coefficient is −24.5,
for MgO, the coefficient is −14.7,
for CaO, the coefficient is 15.2,
for CrO, the coefficient is −17.5,
for BaO, the coefficient is −6.5, and
for ZnO, the coefficient is −7.8.

12. The glass of claim 1, wherein P₂O₅ is less than or equal to than 0.01 mol % of the glass and the glass has a zircon breakdown onset temperature (T_{zbd}) of
$${Tzbd}_{predicted} = \sum ( {Oxide}_{i} \times {Coefficent}_{i} ) + intercept$$
wherein
coefficientᵢ is a coefficient for oxide i, and oxideᵢ is the mol % of oxide i,
the intercept is 1421,
for Al₂O₃, the coefficient is −17.6,
for B₂O₃, the coefficient is −2.2,
for P₂O₅, the coefficient is 0.0,
for Li₂O, the coefficient is −19.7,
for Na₂O, the coefficient is −24.6,
for K₂O, the coefficient is −33.1,
for MgO, the coefficient is −9.2,
for CaO, the coefficient is −9.1,
for CrO, the coefficient is −15.6,
for BaO, the coefficient is −4.2, and
for ZnO, the coefficient is 0.0.

13. A glass comprising:
SiO₂ that is 50 mol % to 77 mol % of the glass;
Al₂O₃ that is 6 mol % to 22 mol % of the glass;
R₂O, wherein R₂O—Al₂O₃ is 9 mol % to 15 mol % of the glass, wherein R is Li, Na, and/or K;
B₂O₃ that is 0 mol % to 10 mol % of the glass;
P₂O₅ that is 0 mol % to 13 mol % of the glass;
Li₂O that is 0 mol % to 10 mol % of the glass;
Na₂O that is 14 mol % to 22 mol % of the glass; and
K₂O that is 0 mol % to 7.6 mol % of the glass;
wherein R₂O—B₂O₃—P₂O₅—Al₂O₃ is less than 5 mol % of the glass.

14. A glass comprising:
SiO₂ that is 60 mol % to 75 mol % of the glass;
Al₂O₃ that is 2 mol % to 22 mol % of the glass;
R₂O, wherein R₂O—Al₂O₃ is 5 mol % to 11 mol % of the glass, wherein R is Li, Na, and/or K;
B₂O₃ that is 0 mol % to 10 mol % of the glass;
P₂O₅ that is 0 mol % to 13 mol % of the glass;
Li₂O that is 0 mol % to 10 mol % of the glass;
Na₂O that is 0 mol % to 14 mol % of the glass; and
K₂O that is 7 mol % to 13 mol % of the glass;
wherein R₂O—B₂O₃—P₂O₅—Al₂O₃ is less than 1.9 mol % of the glass.

15. A starting composition for forming the glass of claim 1, the starting composition comprising the same composition as the glass.

16. A method of processing the glass of claim 1, the method comprising:
processing the glass or starting composition for forming glass at a temperature that does not exceed a predicted T_{zbd}, wherein the predicted T_{zbd} is
$${Tzbd}_{predicted} = \sum ( {Oxide}_{i} \times {Coefficent}_{i} ) + intercept$$
wherein coefficientᵢ is a coefficient for oxide i, and oxideᵢ is the mol % of oxide i;
wherein if P₂O₅ is greater than 0.01 mol % of the glass or starting composition for forming glass, then
the intercept is 1692,
for Al₂O₃, the coefficient is −9.5,
for B₂O₃, the coefficient is −7.2,
for P₂O₅, the coefficient is 20.6,
for Li₂O, the coefficient is −21.4,
for Na₂O, the coefficient is −24.5,
for K₂O, the coefficient is −24.5,
for MgO, the coefficient is −14.7,
for CaO, the coefficient is 15.2,
for CrO, the coefficient is −17.5,
for BaO, the coefficient is −6.5, and
for ZnO, the coefficient is −7.8; and
wherein if P₂O₅ is less than or equal to than 0.01 mol % of the glass or starting composition for forming glass, then
the intercept is 1421,
for Al₂O₃, the coefficient is −17.6,
for B₂O₃, the coefficient is −2.2,
for P₂O₅, the coefficient is 0.0,
for Li₂O, the coefficient is −19.7,
for Na₂O, the coefficient is −24.6,
for K₂O, the coefficient is −33.1,
for MgO, the coefficient is −9.2,
for CaO, the coefficient is −9.1,
for CrO, the coefficient is −15.6,
for BaO, the coefficient is −4.2, and
for ZnO, the coefficient is 0.0.

17. The method of claim 16, wherein the predicted T_{zbd} is 950° C. to 1400° C.

18. The method of claim 16, wherein the method comprises processing the glass or starting composition for forming glass at a temperature that does not exceed the predicted T_{zbd} and that is above 400° C.

19. The method of claim 16, wherein the method comprises processing the glass or starting composition for forming glass at a temperature of 900° C. to 1400° C.

20. The method of claim 16, wherein the method comprises processing the glass or starting composition for forming glass with zircon refractory equipment.
